(19) United States
(12) Patent Application Publication
(10) Pub. No.: US 2024/0167456 A1
(43) Pub. Date: May 23, 2024

(54) ENERGY GENERATION APPARATUS AND METHOD FOR USING SAME

(71) Applicant: MILAD DARAEI AHWAZI, San Antonio, TX (US)

(72) Inventor: MILAD DARAEI AHWAZI, San Antonio, TX (US)

(21) Appl. No.: 18/514,592

(22) Filed: Nov. 20, 2023

Related U.S. Application Data
(60) Provisional application No. 63/427,297, filed on Nov. 22, 2022.

(51) Int. Cl. F03D 9/32; F03D 9/11

(52) U.S. Cl. CPC F03D 9/32; F03D 9/11; F05B 2240/40; F05B 2240/941

(57) ABSTRACT

Presented is an apparatus for generating electricity generated by airflow flowing through a channel on or in a vehicle. The airflow is generated due to the movement of the vehicle. One or more turbines in the channel are turned by the airflow, and the turbines are in operative communication with the generators to create electricity which can be stored on a battery, or other electrical storage device.

This application is based upon and claims priority from U.S. Provisional application Ser. No. 63/427,297, which is incorporated herein by reference.

### BACKGROUND OF THE INVENTION

### Field of the Invention

Applicants' invention relates to a device for converting wind energy to electrical energy and method for same. More particularly, it relates to an apparatus in a vehicle that provides for collection of electrical energy.

### Background Information

The most common way to generate electricity is by spinning a turbine which connects to a generator. This is commonly applied to fossil fuels, where a fuel is burned, creating pressurized steam or gas that spins a turbine and generates electricity. Wind turbines work on the same premise, but they use the wind. The blades of a wind turbine capture kinetic energy from the wind, which causes them to spin. This spinning motion can be converted into electricity.

Wind turbines use wind to make electricity. Wind turns the propeller-like blades of a turbine around a rotor, which spins a generator, which creates electricity. A wind turbine turns wind energy into electricity using the aerodynamic force from the rotor blades, which work like an airplane wing or helicopter rotor blade. When wind flows across the blade, the air pressure on one side of the blade decreases. The difference in air pressure across the two sides of the blade creates both lift and drag. The force of the lift is stronger than the drag and this causes the blades to spin. Or the blades may be angled such that wind moving across them pushes the blades in a certain rotational direction.

The blades are attached to a rotor so when the blades spin, the rotor does likewise. So, wind movement along the X axis of the rotor is converted to rotational movement, or kinetic energy, about the X axis. The rotor is connected to a rotor shaft that rotates along with the rotors. The rotor shaft often is connected to the blades outside of a streamlined housing, or nacelle, and extend inside of the nacelle. The rotor shaft may be in communication with one (1) or more gears, either outside or inside the nacelle, that may mechanically increase or decrease rotations per minute (“rpm”) of a second rotor shaft as compared to the rotor shaft. At lower rpm's, the gears can increase the rpm's of the second shaft sufficiently more than the rotor shaft in order to provide for production of electricity.

The rotor connects to, and is in operative communication with, the generator, either directly (if it's a direct drive turbine) or through a shaft and a series of gears (a gearbox) and a second shaft that speed up the rotation and allow for a physically smaller generator. Any such generators is driven by the translation of aerodynamic force to rotation of a shaft in a generator to create electricity. Alternators and generators are two devices which generate electricity. An alternator can be called a type of generator. An alternator is a charging system for cars that produces electricity. Generators are used in the production of large-scale electricity. Both alternators and generators convert mechanical energy into electrical energy. The main difference between them is in regard to what spins and what is fixed. In an alternator, electricity is produced when a magnetic field spins inside the stator (windings of wire), thus one embodiment of an alternator consists of a stationary set of wire coil windings, inside which a generator rotor revolves. In a generator, on the other hand, the armature or windings of wire spin inside a fixed magnetic field to generate electricity—the generator rotor is an electromagnet supplied with a small amount of electricity through carbon or copper-carbon brushes (contacts) touching two revolving metal slip rings on its shaft.

The “generator,” as used herein, is intended to include many embodiments of energy convertors, including without limitation, a generator, an alternator whether with brushes or brush-less, or a dynamo.

Given rotational movement, or kinetic energy, the motion is used to move a conductor in magnetic field to make electrical energy. The rotor shaft either acts as the generator shaft also, or turns the gears that turn the generator's shaft, which spins a set of magnets around a coil. Moving a magnet (in this case the generator rotor) past a closed loop of wire makes an electric current flow in the wire.

While the battery is essential for starting a car when it's off, the alternator keeps the car alive when the engine is running. The alternator powers most of the car's electronic components while running, including the headlights, electric steering, power windows, windshield wipers, heated seats, dashboard instruments, and radio. The alternator supplies all of them with direct current (DC) power. The alternator is also responsible for charging the car's battery while driving.

Batteries and similar devices accept, store, and release electricity on demand. Batteries use chemistry, in the form of chemical potential, to store energy. For batteries to work, electricity must be converted into a chemical potential form before it can be readily stored. Batteries consist of two electrical terminals called the cathode and the anode, separated by a chemical material called an electrolyte. To accept and release energy, a battery is coupled to an external circuit. Electrons move through the circuit, while simultaneously ions (atoms or molecules with an electric charge) move through the electrolyte. In a rechargeable battery, electrons and ions can move either direction through the circuit and electrolyte. When the electrons move from the cathode to the anode, they increase the chemical potential energy, thus charging the battery; when they move the other direction, they convert this chemical potential energy to electricity in the circuit and discharge the battery. During charging or discharging, the oppositely charged ions move inside the battery through the electrolyte to balance the charge of the electrons moving through the external circuit and produce a sustainable, rechargeable system. Once charged, the battery can be disconnected from the circuit to store the chemical potential energy for later use as electricity.

### SUMMARY OF THE INVENTION

Conventional vehicles use various types of energy to power their movement in multiple types of terrain. In this context, a vehicle can mean any moving thing used to transport people or goods, especially on land, such as a car, truck, or snow machine; on water, such a boat, or ship; or in the ski, such as a plane or helicopter. The vehicle moving is important because it creates its own wind, or airflow, independent of the ambient weather conditions.

The current invention, or energy generation apparatus, uses air flow that is the result of movement of the vehicle, where some air travels through a channel in the vehicle body causing the rotation of fan blades, generating electricity from movement of the vehicle.

The channel directs airflow that is generated by the movement, or travel, by the vehicle in a generally forward direction. As the vehicle moves forward, air enters the channel inlet, travels through the channel, and exits the channel through the channel outlet. The channel inlet may be located in the vehicle front end, while the channel outlet may be located in the vehicle rear end. However, the channel inlet may be located near the vehicle front end, while the channel outlet may be located near the vehicle rear end. Or there may be variations on where the channel inlet and channel outlet are located on the vehicle. Generally though, the channel path is anticipated to be laid out such that the channel provides an airway for air to travel when the vehicle is in motion. It is anticipated that the motion of the vehicle will be forward, but a vehicle that moves omni-directionally can have the channel, or channels, oriented to best capture airflow due to movement of the vehicle in any direction.

The channel is anticipated to provide a path through which air can flow during travel by the vehicle. The channel also provides a location, or locations, to place the turbine, or turbines. Therefore, the channel needs to be sized such that the turbine can fit in the channel and be engaged by the airflow in the channel. The channel has a length, bounded on opposite ends by the inlet and outlet, along which the air flows. As referred to herein, the channel has “sides.” However, it is anticipated that the channel cross-sectional circumference is not limited in shape. The channel may be round or oval or otherwise, and “side” will still refer to a portion of the channel circumference. Likewise, the channel, regardless of its shape, may be referred to as having a “top,” “sides,” and/or “bottom.” Generally, the top of the channel is generally the furthest, generally parallel side from the ground, while the sides are generally perpendicular to the ground, and the bottom is generally the closest parallel side to the ground. So, for example, an open channel that is generally round in cross-section, will have an arced top, and two (2) arced sides, with an open bottom. As another example, a closed channel that is generally rectangular in cross-section, will have a top, two (2) sides, and a bottom. The channel has a length from a channel inlet to a channel outlet.

The channel may be closed or open. Either type of channel has a circumferential channel wall. A closed channel has a wall that extends completely around the channel circumference—creating a hollow interior that is completely enclosed by the channel wall. Thus it is tube-like and once air has entered the channel, the air can only exit through the outlet or inlet. The turbine, and certain associated equipment can fit inside the interior of the channel, although some of the associated equipment is likely to be outside the channel, but in communication with the turbine.

An open channel has a wall that extends partially around the channel circumference—creating a hollow interior that is completely enclosed by the channel wall. Thus it is tube-like and once air has entered the channel, the air can exit through the outlet or inlet, but also along the length of the channel through the open portion of the circumference. The turbine, and certain associated equipment may fit wholly or partially inside the interior of the channel, while some of the associated equipment is likely to be outside the channel, but in communication with the turbine.

Inside the channel, or in the interior, are one (1) or more turbines, each with one (1) or more blades which are angled such that the airflow causes the blades to turn. An alternator (or other embodiment of generator) is in communication with the turbine. Such communication may be mechanical, magnetic, electrical, hydraulic, digital, or other way customary in the trade.

Turning the blades rotates the shaft, the gears, and in turn the alternator rotor and the electromagnet inside the stator coils, which generates electricity in the wiring of the alternator coils. The generated electricity is supplied to the vehicle, a vehicle component, or to a storage cell or battery.

There are two ways that the energy generation apparatus may be incorporated into a vehicle. The first is by designing it into the vehicle such that the energy generation apparatus is integrated into the vehicle when the vehicle is manufactured. If included when the vehicle is being manufactured, it allows for more options as to where the channels and other parts of the energy generation apparatus are positioned in the vehicle. The second is that the energy generation apparatus is added after the vehicle is manufactured. In this embodiment, portions of the energy generation apparatus (e.g. the channels and turbines) are attached to the existing vehicle body or structure. The energy generation apparatus can be attached to the vehicle by bolts, screws, connectors, adhesives, welds, or by other ways customary in the trade. A generator is attached to the vehicle, whether directly to the vehicle or indirectly through some other part that is attached to the vehicle. And, the turbine is in operative communication with said generator. The generator is in operative communication with the battery.

It is anticipated that the storage cell of the energy generation apparatus may be the vehicle's battery that it uses in operating the vehicle, or a storage cell that may be located on the vehicle, but that is separate from the vehicle's operation. Further, it is anticipated that there may be one or more turbines inside each channel. Further, it is anticipated that there may be one or more channels, and that the paths of the channels may be different.

### BRIEF DESCRIPTION OF THE DRAWINGS

FIG. 1 is a side, cutaway view of a vehicle illustrating a channel and turbines.

FIG. 2 is a top, cutaway view of a vehicle illustrating channels and turbines.

FIG. 3 is a front view of a vehicle illustrating channel inlets.

FIG. 4 is a side view of a vehicle illustrating channel inlets and outlets.

FIG. 5 is a perspective, cutaway view of a channel illustrating a turbine.

FIG. 6A-6C are a side, cutaway views of a channel illustrating various embodiments of channel inlet covers.

DETAILED DESCRIPTION OF
THE PREFERRED EMBODIMENT

| Ref. | Element |
|---|---|
| 10 | Vehicle |
| 12 | Vehicle Front End |
| 14 | Vehicle Body |
| 16 | Channel Inlet |
| 18 | Channel |
| 20 | Channel Inlet Rim |
| 22 | Hinge |
| 24 | Cover |
| 26 | Front Bumper |
| 28 | Tire |
| 30 | Wheel |
| 32 | Channel Outlet |
| 34 | Channel Outlet Rim |
| 36 | Vehicle Rear End |
| 38 | Rear Bumper |
| 40 | Turbine |
| 42 | Wheel Well |
| 44 | Blade |
| 46 | Hub |
| 48 | Shaft |
| 50 | Gear Box |
| 52 | Generator |
| 54 | Connector |
| 56 | Rectifier |
| 58 | Support |
| 60 | Hood |
| 62 | Roof |
| 66 | Flap Actuator |
| 68 | Louver Slat |
| 70 | Cable |
| 72 | Pulley |
| 74 | Brace |
| 76 | Pin |
| 78 | Pulley Control Motor |
| 80 | Track |
| 82 | Gate |
| 84 | Bracket |
| 86 | Battery |
| 88 | Channel Outer Wall |
| 90 | Channel Interior |
| 100 | Energy Generation Apparatus |

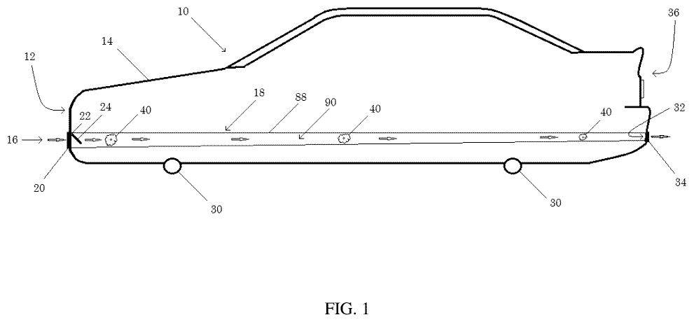

Referring to the figures, FIG. 1 illustrates a vehicle 10 with an embodiment of the energy generation apparatus 100. The vehicle 10 is cut away to illustrate the energy generation apparatus 100 having a channel 18 and turbines 40 within the vehicle 10. The vehicle 10 has a body 14, with a front end 12 and a rear end 36, and if a ground vehicle, may have wheels 30. While the vehicle 10 may travel forward or backward and in different directions, the vehicle 10 is generally intended to travel with its front end 12 forward of the rear end 36. The movement of the vehicle 10 in this manner through air will create airflow generally traveling from the front end 12 toward the back end 36.

The energy generation apparatus 100 is intended to take advantage of this air flow. The energy generation apparatus 100 is comprised, in part, of a channel 18 that generally extends from at or near the front end 12 to at or near the rear end 36. It is anticipated that the channel 18 may be of varying lengths and may begin or end virtually anywhere on the vehicle 10, but that it will generally run front to back, or in the general direction of the air flow. The channel 18 is tubular with an wall 88 about an inner space or interior 90. The wall 88 of the channel 18 is expected to often have a circular, or generally circular, cross-section, but square, rectangular, or other shaped cross sections are all anticipated.

Airflow enters the channel 18 at the channel inlet 16, which is an aperture bordered about its circumference by an inlet rim 20. The channel inlet 16 leads into the interior 90 of the channel 18. At or near the rear end 36, the channel 18 ends at a channel outlet 32. The channel outlet 32 is an aperture bordered about its circumference by an outlet rim 34. Air flow enters the channel inlet 16 and travels the length of the channel 18, then exits the channel 18 through the channel outlet 32. The channel 18 may be opened or closed near the inlet 16 by use of a cover 24 on a rotatable hinge 22. The cover 24 may be opened to all airflow through the inlet 20 and through the channel 18, or closed in order to restrict airflow from the channel 18.

One or more turbines 40 are attached to the channel wall 88 and located in the interior 90. The turbines 40 are oriented such that the front to back airflow will activate the blades 44 of the turbine 40 causing them to rotate.

While the energy generation apparatus 100 is intended to include a single (1) turbine 40 in a single (1) channel 18, users may optimize energy production by including two (2), three (3) or more turbines 40 in a single channel 18. A multiplicity of turbines 40 may provide for increased energy production.

If desired, the diameter of the interior 90 may be decreased (thus likewise the circumference of the wall 88 gets smaller) as the channel 18 gets nearer the rear end 36 in order to increase the speed of the airflow. Air flowing down the interior 90 is a steadily moving fluid. As the air flow moves into the narrower channel 18, it must move faster, because the same amount of air is flowing through a narrower region. The increased speed of the airflow can result in increased revolution rate of the blades 44.

It should be noted that the air flow in the channel 18 could be used as a convection current to cool various parts of the vehicle 10.

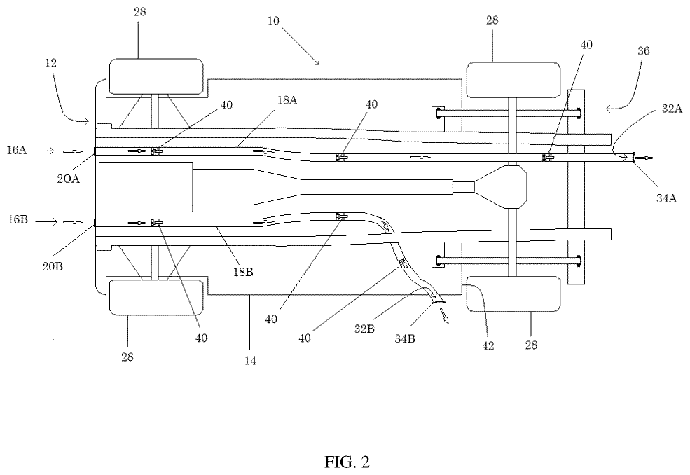

FIG. 2 illustrates the channels 18 and turbines 40 in a vehicle 10. In this figure, the vehicle is shown with the body 14, front end 12, rear end 36, and tires 28. FIG. 2 illustrates that there may be multiple embodiments of which the energy generation apparatus 100 may take the form. As illustrated here, there may be a multiplicity of channels—in this instance first channel 18A and second channel 18B. It should be noted that there may only be one (1) channel 18, a multiplicity of channels 18, and that the number of channels 18, if a multiplicity, may be more than two (2). Each channel 18 may have a multiplicity of turbines 40. And, the paths of first channel 18A and second channel 18B may be different. Although not limiting, FIG. 2 illustrates first channel 18A as going from the first inlet 16A in the vehicle front end 12, through the vehicle body 14, and exiting through the first outlet 32A in the rear end 36. While second channel 18B is illustrated going from the second inlet 16B in the vehicle front end 12, through the vehicle body 14, and exiting through second outlet 32B on the side of the vehicle 10 in front of the wheel well 42 near the rear end 36. The varying number of channels 18 and route of channels 18 may be altered to best fit the body style of the vehicle 10, and to best collect the air flow.

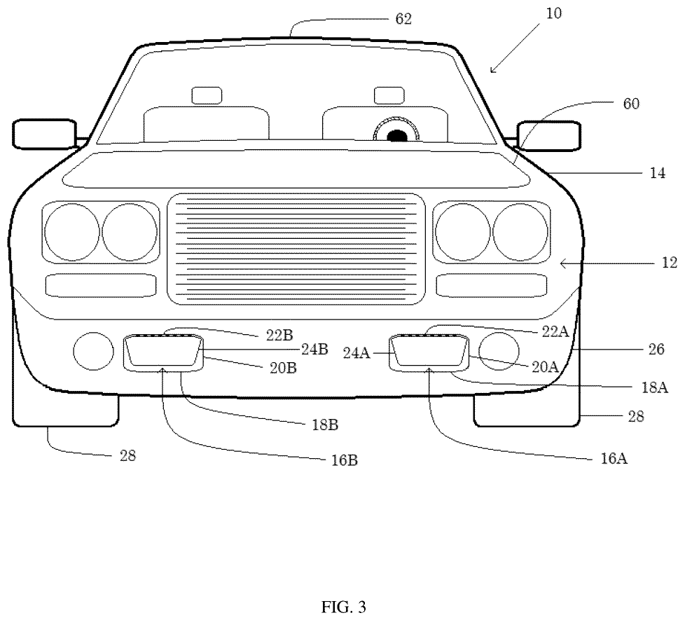

FIG. 3 illustrates the front end 12 of the vehicle 10 with channel inlets 16A and 16B leading into channels 18A and 18B respectively. The vehicle 10 is shown with body 14, roof 62, hood 60, front bumper 26, and tires 28. About the circumference of inlets 16A and 16B are inlet rims 20A and 20B respectively. Because there are times when it may not be desirable to have the channels 18A and 18B open to the environment, access may be opened or closed using covers 24A and 24B, which rotate open and closed on hinges 22A and 22B.

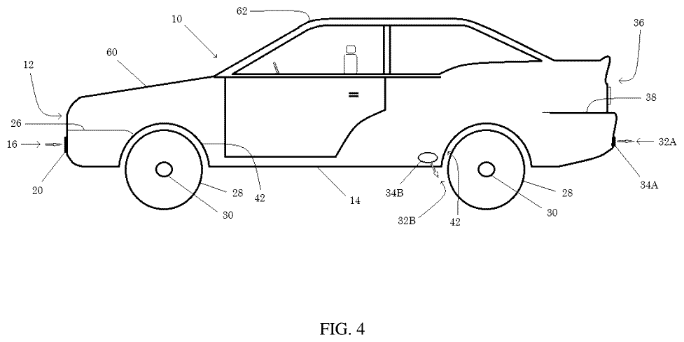

FIG. 4 illustrates a side view of a vehicle 100. FIG. 4 compliments FIG. 2 in that FIG. 4 illustrates a channel inlet 16 at the front end 12. It further illustrates a first outlet 34A at the rear end 36, while a second outlet 34B is along the side of the vehicle 10 near wheel well 42.

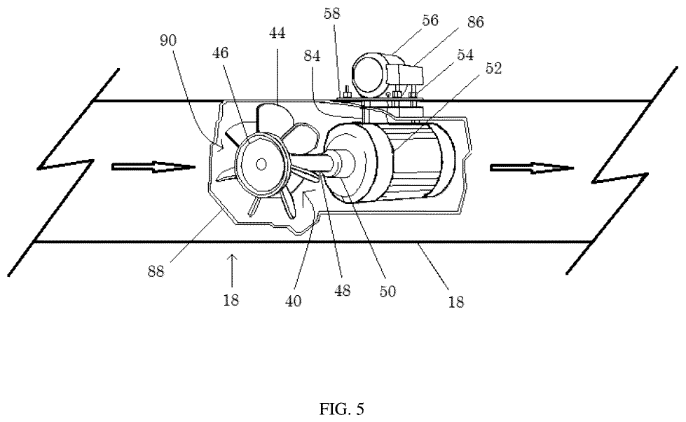

FIG. 5 is a cut away and illustrates a turbine 40 that is located in the interior 90 of the channel 18, and that is surrounded by the wall 88. The direction of the airflow is indicated by the arrows. The blades are connected at the hub 46. The airflow causes the blades 44 to rotate, thus also rotating the hub 46. A rotor shaft 48 first end is attached to the hub 46, so when the hub 46 rotates, the rotor shaft 48 rotates as well. The profile of the blade 44 is designed, shaped and oriented in order to obtain a good value of aerodynamic lift or rotation from the passing airflow. It is anticipated that the construction materials should be light but strong, such as, without limitation, fiberglass, titanium, plastic, aluminum, or carbon fiber. A brake (not shown) may be placed in communication with the blade 44, hub 46, or shaft 48. A brake (not shown) can be different (mechanical, electrical, hydraulic), and is used to avoid the generator rotor (not shown) movement when the turbine 40 has to be kept in non-operating condition.

A gear-box 50 (having one or more stages of gears) may be used to communicate the mechanical power of the shaft 48 to the generator rotor (not shown), by increasing the rotational speed and by decreasing the torque, in order to permit an efficient conversion of energy. The design of the gear box 50 may involve various types and numbers of gears (not shown), and may be integrated with the generator, or separate therefrom. Conversely, the gear box may act as a speed regulator on the turbine, so that if a slower rotation rate is desired, there is a way to do so. There are many embodiments of the gear box that can allow it to slow the turbine's rotational speed, such as by gears, brakes, or other ways customary in the trade.

The generator 52 converts the mechanical energy of the connected generator rotor (not shown) to electrical energy. As is well known, and in varying embodiments, the shaft 48 and gears 50 turn the generator's rotor (not shown), which spins a set of magnets (not shown) around a coil (not shown). These spinning magnets (not shown) generate alternating current (AC) around the coil (not shown), which is then channeled to the generator's rectifier 56. The rectifier 56 converts that AC power into DC power which is transmitted through wiring (not shown) to a storage cell or battery 86, or the power may be supplied to some other desired component (not shown).

The turbine 40 and the generator 52 are held in place by connectors 54 and supports 58. The hub 46 and associated blades 44 are generally kept in place centered in the interior 90. Generally the outer tip of the blade 44 should not contact the wall 88, but it may be desirable to have a narrow tolerance between them. However, the generator 52 may be installed either inside or outside of the channel 18 depending upon the desired placement.

Thus, the blade 44 is in mechanical, or operative, communication with the generator 52, transmitting the extracted wind power. And the generator 52 is in electrical, or operative, communication with the battery 86 or other component, transmitting the generated electrical power.

It should be noted that a fan-type turbine 40 with a hub 46 and blades 44 has been described as an example embodiment herein, however there are many types and embodiments of turbines 40, blades 44, and hubs 46 or without hubs, that would effectively turn inside the channel 18. Thus, “turbine” as used herein is intended to include these other embodiments.

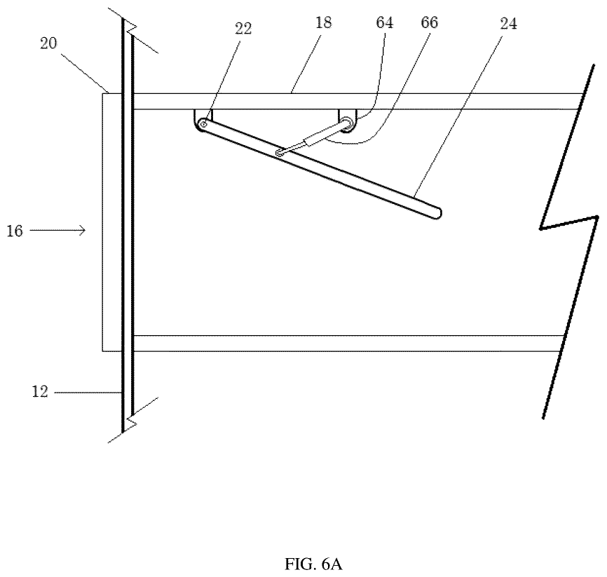

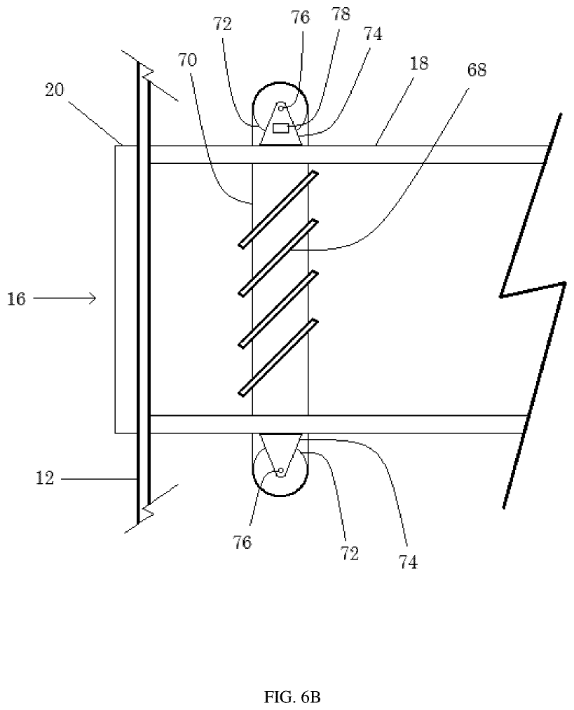

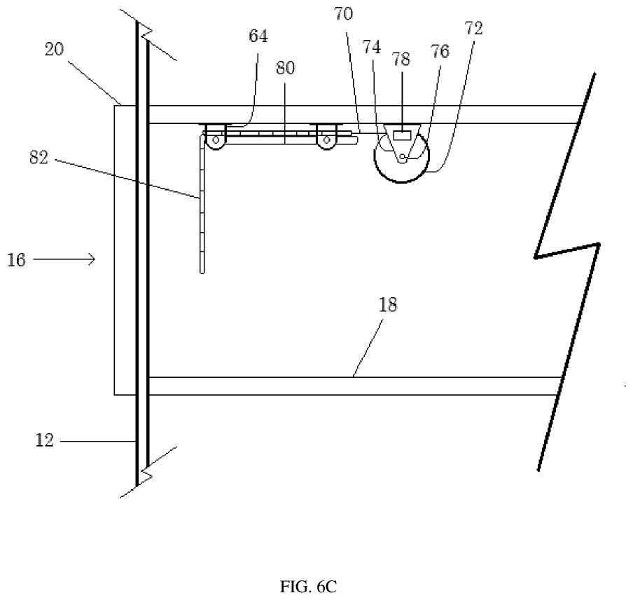

FIGS. 6A-6C are a side, cutaway views of a channel illustrating various embodiments of channel inlet covers 24 inside the channel 18. The cover 24, regardless of the embodiment, will generally be at or near the inlet 16 and inlet rim 20. The inlet cover 24 may be opened to allow airflow into said channel 18, or closed to keep airflow out of said channel 18. It is anticipated that there are a plethora of cover embodiments that would be effective in use with the energy generation apparatus 100. FIG. 6A illustrates a first embodiment of a cover 24 that is swung open and closed about a rotating hinge 22. The cover 24 is powered open and closed by a flap actuator 66 that may be rotatable at an anchor 64. FIG. 6B illustrates a second embodiment of a cover 24 which is made of louver slats 68. The louver slats 68 may be swung open and closed by a rod or cable 70 on pulleys 72 that rotate about pins 76 and are held in place by braces 74, where the rod or cable 70 is moved by a pulley control motor 78. FIG. 6C illustrates a third embodiment of a cover 24 in which a sectional or rollup gate 82. The gate 82 may move on track 80 which is attached to the channel 18 by anchors 64. A rod or cable 70 is attached between the gate 82 and a pulley 72 anchored to the wall 88 by a brace 74 and rotating about a pin 76. A pulley control motor provides power to open or close the gate 82. It should be understood that the flap/cover/gate is an option, but not a requirement for the energy generation apparatus 100.

Unless otherwise specifically noted, the elements and articles depicted in the drawings are drawn to scale for particular embodiments and illustrative of still other embodiments. The drawings demonstrate examples of the described, mentioned, and/or suggested embodiments and are intended to disclose the elements and articles illustrated as part of the specification. Moreover, the drawings also indicate relative size, angles, shapes, arrangement, orientation, placement, and like information to one of ordinary skill in the art regarding the elements and articles in the drawings. The drawings are intended to disclose the elements and articles illustrated in them” as part of the specification.

Throughout this disclosure, a hyphenated form of a reference numeral refers to a specific instance of an element and the un-hyphenated form of the reference numeral refers to the element generically or collectively. Thus for example, widget 12-1 would refer to a specific widget of a widget class 12, while the class of widgets may be referred to collectively as widgets 12 and any one of which may be referred to generically as a widget 12.

As used herein, “removably attached,” “removably attachable,” or “removable” mean that a first object that is coupled to a second object may be decoupled from the second object, or taken away from an attached position relative to the second object, using some force or movement.

“Removably attached,” “removably attachable,” or “removable” further mean that if the first object is not coupled with the second object, the first object may be coupled to the second object or returned to the attached position, using some force or movement. Both the decoupling and the coupling may be accomplished without damaging either the first object or the second object.

When the terms “substantially,” “approximately,” “about,” or “generally” are used herein to modify a numeric value, range of numeric values, or list numeric values, the term modifies each of the numerals. Unless otherwise indicated, all numbers expressing quantities, units, percentages, and the like used in the present specification and associated claims are to be understood as being modified in all instances by the terms “approximately,” “about,” and “generally.” As used herein, the term “approximately” encompasses+/−5 of each numerical value. For example, if the numerical value is “approximately 80,” then it can be 80+/−5, equivalent to 75 to 85. As used herein, the term “about” encompasses+/−10 of each numerical value. For example, if the numerical value is “about 80,” then it can be 80+/−10, equivalent to 70 to 90. As used herein, the term “generally” encompasses+/−15 of each numerical value. For example, if the numerical value is “about 80,” then it can be 80%+/−15, equivalent to 65 to 95. Accordingly, unless indicated to the contrary, the numerical parameters (regardless of the units) set forth in the following specification and attached claims are approximations that may vary depending upon the desired properties sought to be obtained by the exemplary embodiments described herein. In some ranges, it is possible that some of the lower limits (as modified) may be greater than some of the upper limits (as modified), but one skilled in the art will recognize that the selected subset will require the selection of an upper limit in excess of the selected lower limit.

At the very least, and not limiting the application of the doctrine of equivalents to the scope of the claim, each numerical parameter should at least be construed in light of the number of reported significant digits and by applying ordinary rounding techniques.

The terms “inhibiting” or “reducing” or any variation of these terms refer to any measurable decrease, or complete inhibition, of a desired result. The terms “promote” or “increase” or any variation of these terms includes any measurable increase, or completion, of a desired result.

The term “effective,” as that term is used in the specification and/or claims, means adequate to accomplish a desired, expected, or intended result.

The terms “a” or “an” when used in conjunction with the term “comprising” in the claims and/or the specification may mean “one,” but it is also consistent with the meaning of “one or more,” “at least one,” and “one or more than one.”

The term “each” refers to each member of a set, or each member of a subset of a set.

The terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In interpreting the claims appended hereto, it is not intended that any of the appended claims or claim elements invoke 35 U.S.C. 112(f) unless the words “means for” or “step for” are explicitly used in the particular claim.

It should be understood that, although exemplary embodiments are illustrated in the figures and description, the principles of the present disclosure may be implemented using any number of techniques, whether currently known or not. The present disclosure should in no way be limited to the exemplary implementations and techniques illustrated in the drawings and description herein. Thus, although the invention has been described with reference to specific embodiments, this description is not meant to be construed in a limited sense. Various embodiments may include some, none, or all of the enumerated advantages. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. Modifications, additions, or omissions may be made to the systems, apparatuses, and methods described herein without departing from the scope of the disclosure. For example, the operations of the systems and apparatuses disclosed herein may be performed by more, fewer, or other components in the methods described may include more, fewer, or other steps. Additionally, steps may be performed in any suitable order.

I claim:

1. An apparatus for generating electricity from movement of a vehicle having a front end and a rear end and operated by a user, comprising:
a channel;
wherein said channel has a length from a channel inlet to a channel outlet, and is bordered by a channel wall comprising a top and two sides;
wherein side channel has an interior that extends from said channel inlet to said channel outlet;
wherein said channel wall is incorporated with said vehicle;
a turbine located in said interior;
a generator attached to said vehicle, wherein said turbine is in operative communication with said generator; and
a battery in operative communication with said generator.

2. The apparatus of claim 1, wherein said channel generally extends from at or near the front end to at or near the rear end.

3. The apparatus of claim 1, wherein said channel wall further comprises a bottom.

4. The apparatus of claim 1, wherein there are a multiplicity of turbines located in said interior.

5. The apparatus of claim 1, wherein said inlet is located at said front end, and said outlet is located at said rear end.

6. The apparatus of claim 3, further comprising an inlet cover located at or near said inlet, wherein said inlet cover may be opened to allow airflow into said channel, or closed to keep airflow out of said channel.

7. The apparatus of claim 1, wherein said channel wall further comprises a bottom.

8. The apparatus of claim 7, wherein there is a multiplicity of turbines located in said interior.

9. The apparatus of claim 8, further comprising:
an inlet cover located at or near said inlet;
wherein said inlet cover may be opened to allow airflow into said channel, or closed to keep airflow out of said channel.

10. The apparatus of claim 2, wherein said channel wall further comprises a bottom.

11. The apparatus of claim 10, wherein there is a multiplicity of turbines located in said interior.

12. The apparatus of claim 11, further comprising an inlet cover located at or near said inlet, wherein said inlet cover may be opened to allow airflow into said channel, or closed to keep airflow out of said channel.

13. The apparatus of claim 1, further comprising:
a generator;
wherein said turbine is in operative communication with said generator;
a battery; and
wherein said generator is in operative communication with said battery.

14. The apparatus of claim 13, wherein said channel generally extends from at or near the front end to at or near the rear end.

15. The apparatus of claim 13, wherein said channel wall further comprises a bottom.

16. The apparatus of claim 13, further comprising:
a multiplicity of turbines, wherein each of said turbines is located in said interior; and
wherein each of said multiplicity of turbines is in operative communication with said generator.

17. The apparatus of claim 13, further comprising:
a multiplicity of turbines, wherein each of said turbines is located in said interior;
a multiplicity of generators, wherein each of said multiplicity of turbines is in operative communication with one of said multiplicity of generators.

18. The apparatus of claim 16, wherein said inlet is located at said front end, and said outlet is located at said rear end.

19. The apparatus of claim 18, further comprising an inlet cover located at or near said inlet, wherein said inlet cover may be opened to allow airflow into said channel, or closed to keep airflow out of said channel.
